(19) United States
(12) Patent Application Publication
(10) Pub. No.: US 2026/0239409 A1
(43) Pub. Date: Aug. 13, 2026

(54) ST RECOVERY AND REPORTING FOR SL MODE-1

(71) Applicant: InterDigital Patent Holdings, Inc., Wilmington, DE (US)

(72) Inventors: Faris Alfarhan, Montreal (CA); Martino Freda, Laval (CA); Tao Deng, New York, NY (US); Tuong Hoang, Montreal (CA); Moon IL Lee, Melville, NY (US)

(73) Assignee: InterDigital Patent Holdings, Inc., Wilmington, DE (US)

(21) Appl. No.: 19/154,171

(22) PCT Filed: Mar. 7, 2024
(86) PCT No.: PCT/US2024/018906

§ 371 Date: Aug. 6, 2025

Related U.S. Application Data
(60) Provisional application No. 63/489,010, filed on Mar. 8, 2023.

(51) Int. Cl. H04W 72/543; H04L 1/00; H04W 72/12; H04W 72/25; H04W 92/18

(52) U.S. Cl. CPC H04W 72/543; H04L 1/0003; H04W 72/12; H04W 72/25; H04W 92/18

(57) ABSTRACT

A wireless transmit/receive unit (WTRU) may receive configuration information indicating transmissions for a data radio bearer (DRB) associated with sidelink (SL) transmission can be performed in a regular quality of service (QoS) state or in a limited survival time QoS state (LSTQoSS), and a scheduling request (SR) configuration for indicating SL transmission failure for the DRB when in LSTQoSS. The WTRU may use LSTQoSS for the DRB. The WTRU may determine that at least one transport block (TB) including data of the DRB that was transmitted in accordance with the LSTQoSS failed. The WTRU may send a SR in accordance with the SR configuration for indicating SL transmission failure for the DRB when the DRB is in the LSTQoSS if at least one TB including data of the DRB that was transmitted in accordance with LSTQoSS failed. The WTRU may send another transmission for the DRB in accordance with LSQoSS.

### CROSS-REFERENCE TO RELATED APPLICATION

This application claims priority to U.S. Provisional Patent Application No. 63/489,010 filed Mar. 8, 2023, the entire contents of which are incorporated herein by reference.

### BACKGROUND

This disclosure pertains to devices, methods, and systems for low latency quality of service (QoS) over sidelink.

### SUMMARY

Devices, methods, and/or systems for low latency quality of service (QoS) over sidelink (SL) are described herein. In one or more examples, a wireless transmit/receive unit (WTRU) may be configured for triggering of added reliability on Sidelink for low latency services. In one or more implementations, the WTRU may be configured for sidelink resource selection. In one or more implementations, the WTRU may be configured for QoS attainment. In one or more implementations, the WTRU may be configured for Listen-Before-Talk (LBT). In one or more examples, the WTRU may be configured for SL preemption and/or prioritization.

Devices, methods, and systems for enabling survival time (ST) triggering and recovery for SL mode-2 are described herein. For example, the WTRU may be configured with one or more data radio bearers (DRB) for which ST QoS requirement is applicable. Further, the WTRU may be configured with one or more resource pools for SL transmission mode-2. The WTRU may trigger a ST state for increased transmission reliability to transmit the next transport block (TB). The WTRU may trigger a ST state for increased transmission reliability to transmit the next TB based on making a channel measurement above a configured threshold and/or determining that a transmission on the configured SL resource was dropped due to channel occupancy ratio (CR). The WTRU determines a channel measurement is above a configured threshold, for example, but not limited to, when a channel busy ratio (CBR) and/or CR is measured above a threshold, a reference signal received power (RSRP) associated with SL control information (SCI) received from other WTRUs is measured above a threshold and/or a CQI is measured less than a threshold. The WTRU may trigger a ST state for increased transmission reliability. Further, during the ST state, the WTRU may start a ST timer upon triggering the ST state. During the ST state, the WTRU may adjust the resource selection window such that the next new SL transmission terminates within the remaining time in the ST timer. During the ST state, the WTRU may increase the TB priority for TB transmissions on SL resources in the resource selection procedure. During the ST state, the WTRU may bypass a CBR and/or CR congestion control, for example, if a previous packet failed. During the ST state, for example, the WTRU may select a different SL resource (or resource pool) based on measured CR and/or CBR. If the WTRU is in coverage, for example, the WTRU may report to a gNB a transmission failure or CBR/CR being above a threshold. (e.g., in a medium access control control element (MAC CE), an scheduling request (SR), and/or on physical uplink control channel (PUCCH)). For example, the WTRU may report a negative acknowledgement (NACK).

A wireless transmit/receive unit (WTRU) may receive configuration information. The configuration may indicate that transmissions for a data radio bearer (DRB) associated with sidelink (SL) transmission can be performed in a regular quality of service (QoS) state and/or in a limited survival time QoS state. The configuration information may indicate a scheduling request (SR) configuration for indicating SL transmission failure for the DRB when the DRB is in the limited survival time QoS state. The WTRU may determine to use the limited survival time QoS state for the DRB. The WTRU may determine that at least one transport block (TB) including data of the DRB that was transmitted in accordance with the limited survival time QoS state has failed. The WTRU may send a SR in accordance with the SR configuration for indicating SL transmission failure for the DRB when the DRB is in the limited survival time QoS state based on determining that the at least one TB including data of the DRB that was transmitted in accordance with the limited survival time QoS state has failed. The WTRU may send a new transmission for the DRB in accordance with the limited survival time QoS state. The new transmission may be sent in a different resource pool. In the limited survival time QoS state, the WTRU may be configured to select at least one grant for the transmission. The selected at least one grant may correspond to at least one of: a grant having a highest relative reliability for a modulation and coding scheme (MCS) of a plurality of available grants, a configured grant associated with the limited survival QoS state, and/or a plurality of configured grants used for duplication of the new transmission.

The WTRU may determine to use transmission parameters associated with the limited survival time QoS state for the DRB, and/or send the new transmission for the DRB in accordance with the transmission parameters associated with the limited survival time QoS state.

The WTRU may duplicate one or more TB transmissions on one or more configured grants (CGs). When the WTRU is in coverage, for example, the WTRU may send a report to a network. The report may include a transmission failure, a channel busy ratio (CBR) being above a threshold, and/or a channel occupancy ratio (CR) being above a threshold.

The WTRU may start a survival time timer. The WTRU may start the survival time timer based on a pre-emption determination. The WTRU may start the survival time timer based on a sensing-based determination. While the survival time timer is running, for example, the WTRU may temporarily disable congestion control and/or a channel occupancy ration (CR) limit. While the survival time timer is running, for example, the WTRU may activate autonomous blind retransmissions and/or increase the number of autonomous repetitions. The WTRU may stop the survival time timer based on reception of an acknowledgement for a first TB and/or a second TB, reception of SL control information (SCI), expiry of the survival time timer, reception of an indication from a network, and/or one or more channel measurements.

### BRIEF DESCRIPTION OF THE DRAWINGS

A more detailed understanding may be had from the following description, given by way of example in conjunction with the accompanying drawings, in which like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A.

### DETAILED DESCRIPTION

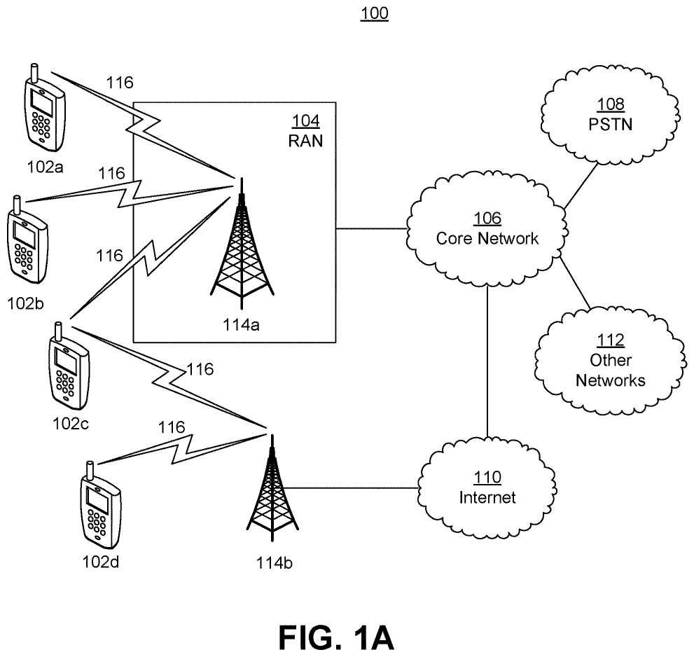

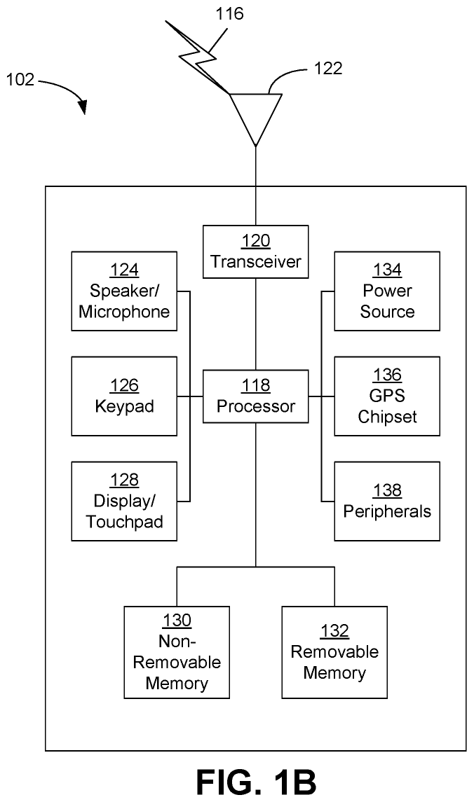

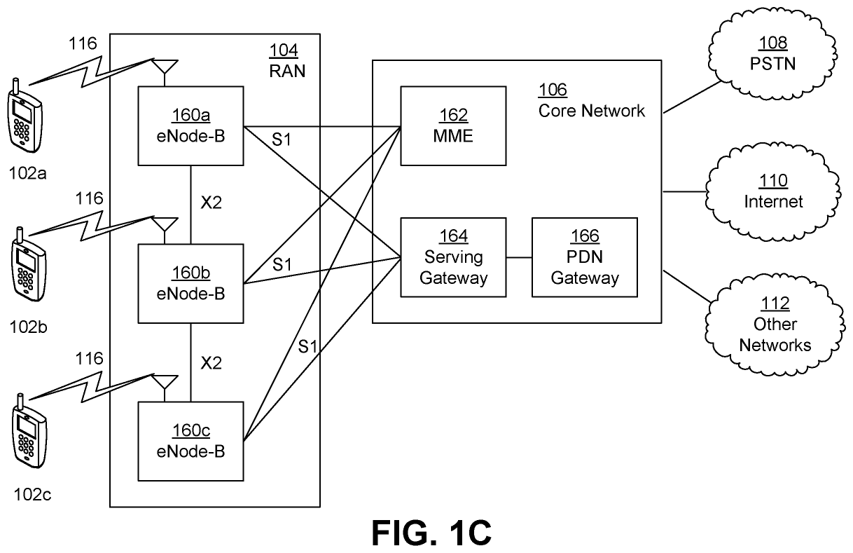

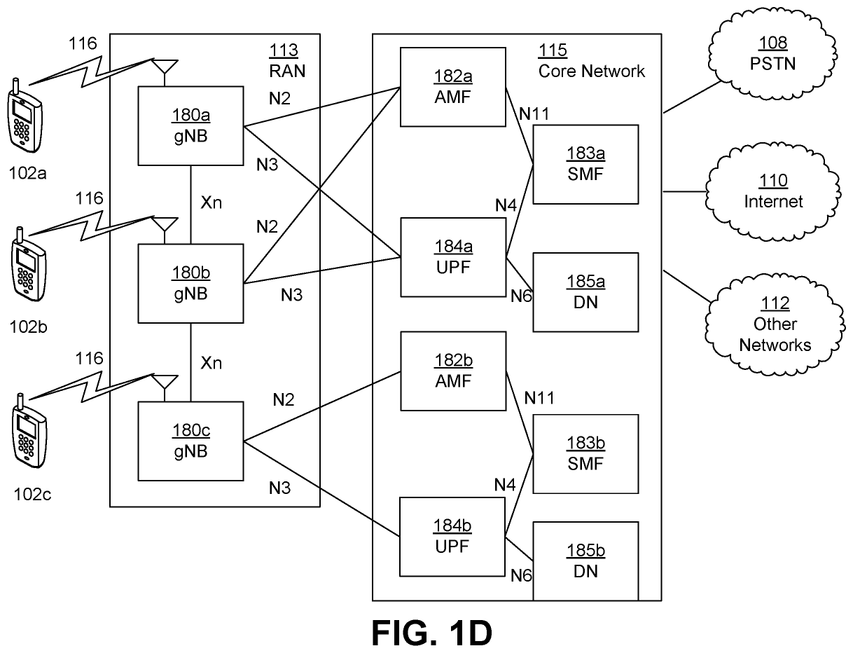

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUS 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, in which the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms, among others, are used herein: Acknowledgement (ACK); Block Error Rate (BLER); Bandwidth Part (BWP); Channel Access Priority (CAP); Channel access priority class (CAPC); Clear Channel Assessment (CCA); Control Channel Element (CCE); Control Element (CE); Configured Grant or Cell Group (CG); Cyclic Prefix (CP); Conventional OFDM (relying on cyclic prefix) (CP-OFDM); Channel Quality Indicator (CQI); Cyclic Redundancy Check (CRC); Channel State Information (CSI); Contention Window (CW); Contention Window Size (CWS); Channel Occupancy (CO); Downlink Assignment Index (DAI); Downlink Control Information (DCI); Downlink feedback information (DFI); Dynamic grant (DG); Downlink (DL); Demodulation Reference Signal (DM-RS); Data Radio Bearer (DRB); enhanced Licensed Assisted Access (eLAA); Further enhanced Licensed Assisted Access (FeLAA); Hybrid Automatic Repeat Request (HARQ); License Assisted Access (LAA); Listen-Before-Talk (LBT); Long Term Evolution (e.g., from 3GPP LTE R8 and up) (LTE); Negative ACK (NACK); Modulation and Coding Scheme (MCS); Multiple Input Multiple Output (MIMO); New Radio (NR); Orthogonal Frequency-Division Multiplexing (OFDM); Physical Layer (PHY); Process ID (PID); Paging Occasion (PO); Physical Random Access Channel (PRACH); Primary Synchronization Signal (PSS); Random Access (or procedure) (RA); Random Access Channel (RACH); Random Access Response (RAR); Radio access network Central Unit (RCU); Radio Front end (RF); Radio Link Failure (RLF); Radio Link Monitoring (RLM); Radio Network Identifier (RNTI); RACH occasion (RO); Radio Resource Control (RRC); Radio Resource Management (RRM); Reference Signal (RS); Reference Signal Received Power (RSRP); Received Signal Strength Indicator (RSSI); Service Data Unit (SDU); Sounding Reference Signal (SRS); Synchronization Signal (SS); Secondary Synchronization Signal (SSS); Switching Gap (in a self-contained subframe) (SWG); Semi-persistent scheduling (SPS); Supplemental Uplink (SUL); Transport Block (TB); Transport Block Size (TBS); Transmission-Reception Point (TRP); Time-sensitive communications (TSC); Time-sensitive networking (TSN); Uplink (UL); Ultra-Reliable and Low Latency Communications (URLLC); Wide Bandwidth Part (WBWP); Wireless Local Area Networks and related technologies (IEEE 802.xx domain) (WLAN).

In examples, NR may support one or more services of different quality of service (QoS) requirements, for example, including traffic of one or more (e.g., varying) latency and/or reliability requirements.

In a NR system, data packets originate in the application layer from an application. The non-access stratum (NAS) layer assigns QoS requirements and/or mapping rules. NAS maps a data/IP flows carrying data packets to a QoS flow and configures a QoS flow ID (QFI) for one or more (e.g., each) QoS flow. One or more (e.g., all) data packets within the same QoS flow may have the same QFI. The access stratum (AS) layer may map a QoS flow to radio layer resources, in which the service data adaptation protocol (SDAP) entity within the WTRU maps a QoS flow to a data radio bearer (DRB). One or more (e.g., all) data packets mapped to the same DRB may have the same transmission treatment in AS (e.g., from a radio interface perspective). SDAP QoS flow to DRB mapping rules may be configured semi-statically in radio resource control (RRC). The WTRU-SDAP may map an SDU to a DRB according to the configured rules, and/or to the default DRB, for example, if no rules are configured. RRC may configure one or more (e.g., each) DRB with one or more logical channels (LCHs). The logical channel prioritization (LCP) function in WTRU-MAC may allocate uplink radio resources among the LCHs with buffered data in the WTRU, for example, based on configured QoS related LCP parameters. The QoS related LCP parameters may include, for example, LCH's priority, the LCH's prioritized bit rate (PBR), bucket size duration (BSD), and/or the LCH's LCP mapping restrictions configured per LCH.

NR may support time-sensitive communications and/or networking, including deterministic and/or non-deterministic Time Sensitive Networks (TSN) and/or Time Sensitive Communications (TSC) traffic patterns and/or flows. The TSN and/or TSC traffic patterns and/or flows may be prevalent in factory automation settings using licensed and/or unlicensed spectrum.

TSN/TSC may include parameters that are signaled to RAN in a TSC assistance information (TSCAI). This may include survival time (e.g., the amount of time an application can handle failed transmissions before the over-all application fails). TSCAI may define the service availability, reliability, and/or burst spread for periodic bursts (e.g., the spread over which each burst may be present due to jitter-like behavior). One or more (e.g., each) bursts may represent an application message that can be delivered via a single packet data convergence protocol (PDCP) SDU (and/or via one or more (e.g., multiple) SDUs).

Survival Time (ST) may be a way to guarantee communication service availability (CSA), which may be the percentage of time a service is available, and/or communication service reliability (CSR), which may be the allowed mean time between failures. ST may be for one or more (e.g., any) transmissions of an application. ST may not indicate a reliability of a packet itself, as one or more (e.g., any) packet may (e.g., may need to) be transmitted successfully for survival time to not be an issue. For example, if there are transmissions associated with every slot and the survival time is 2 slots, the system may handle 1 failed transmission. If the first transmission fails, for example, the second transmission may be successful. The second transmission may not be a retransmission of the first transmission. Rather, the second transmission may (e.g., may need to) be part of the application/service. When the survival time is about to expire (and in some cases, is of the order of 0.5ms), the transmitter may increase the robustness of its transmissions to make sure at least one packet is delivered successfully. The relevant ST requirements to consider may include one or more requirements associated with the periodic deterministic communication service. In R17, for example, upon determining a NACK for a given message transmitted on physical uplink shared channel (PUSCH), the WTRU may activate PDCP duplication for the next TB to prevent failure of subsequent messages. The assumption is such traffic is periodic and successful transmission (tx) of one or more (e.g., any) subsequent TBs with duplication would satisfy the ST requirement. One or more (e.g., all) radio link control (RLC) entities configured for the DRB with ST data may be activated by the WTRU for duplication.

As soon as one message transmission fails, for example, a message may (e.g., must) be delivered successfully before the survival time requirement has elapsed; otherwise the ST may be violated. As described herein, the second transmission may not (e.g., need to) be a retransmission of the first transmission. Rather, the second transmission may (e.g., may need) to be part of the application/service. When the survival time is about to expire and/or upon triggering survival time state, for example, the transmitter may increase the robustness of its transmissions to make sure at least one packet is delivered successfully before the survival time has elapsed. For non-stringent communication services, the gNB may have enough time to safely react to ST and reconfigure transmissions serving the traffic before the ST deadline. For the more stringent case(s), relying on the gNB alone may not be sufficient to satisfy the requirements. For instance, in SL, the gNB may not (e.g., always) ensure survival time QoS requirements are met. For example, in mode 2, the gNB may not be involved if the WTRU is out of coverage. In examples, in mode 1, gNB involvement may not be timely as the gNB is considered a third party not participating in the application. For the cases in which ST is more relaxed, the gNB scheduler may be helpful to react (e.g., may allow for a reaction) before the survival time has elapsed.

Embodiments described herein may include a WTRU that is configured for ST triggering and recovery for both SL modes. The WTRU may be configured with one or more DRBs for which survival time QoS requirement is applicable. The WTRU may determine that a transmission on a SL resource has failed. For example, the WTRU may determine that the transmission on a SL resource has failed based on one or more of: receiving a physical sidelink feedback channel (PSFCH) and/or SCI indicating a failure from a peer WTRU; a TB being dropped due to an overlapping Uu transmission; and/or a TB being dropped due to preemption by another SL transmission. The WTRU may trigger a survival time state for increased transmission reliability. The WTRU may start a ST timer, for example, upon triggering that ST state. The WTRU may be deactivate the ST state, for example, upon expiration of a ST timer and/or receiving an acknowledgement (ACK) from the peer WTRU. During the ST state, the WTRU may perform one or more of the following. During the ST state, the WTRU may increase the transmit power level associated with one or more other (e.g., new) SL transmissions. During the ST state, the WTRU may increase the TB priority for one or more other (e.g., new) TB transmissions on SL resources. During the ST state, the WTRU may activate autonomous blind retransmissions and/or repetitions. During the ST state, the WTRU may override dropping rules such that SL transmissions with DRBs configured with ST are (e.g., always) prioritized over other SL and/or Uu transmissions.

Embodiments described herein may be with respect to a WTRU configured for ST triggering and recovery for a SL-U scenario. The WTRU may be configured with one or more DRB for which ST QoS requirement is applicable. The WTRU may be configured with a plurality of SL resources on different resource block (RB) sets of independent LBT channel acquisition procedures. The WTRU may detect an LBT failure to transmit on a SL resource on a given RB set. The WTRU may trigger a ST state for increased transmission reliability to transmit the next TB. During survival time state, the WTRU may perform one or more of the following. During the survival time state, the WTRU may transmit and/or retransmit TB on a different RB set. During the survival time state, the WTRU may attempt to transmit TB duplicates on a plurality of RB sets. During the survival time state, the WTRU may transmit transport blocks with short LBT and/or no LBT configuration.

Embodiments are described herein with respect to a WTRU configured for ST recovery and reporting for SL mode-1. The WTRU may be configured with one or more DRB for which ST QoS requirement is applicable. The WTRU may be configured with an SR configuration for reporting SL transmission failures for DRBs configured with a ST requirement. For example, the WTRU may receive configuration information. The configuration information may indicate that transmissions for a DRB associated with SL can be performed in a regular QoS state and/or in a limited survival time QoS state. The configuration information may indicate a SR configuration for indicating SL transmission failure for the DRB when the DRB is in the limited survival time QoS state. The WTRU may determine to use the limited survival time QoS state for the DRB. The WTRU may determine that a TB transmission has failed on a SL resource. For example, the WTRU may determine that at least one TB including data of the DRB that was transmitted in accordance with the limited survival time QoS state has failed. The WTRU may trigger a ST state for increased transmission reliability. The WTRU may trigger new SR for reporting a SL transmission failure and/or may transmit the SR on the PUCCH resource of the associated SR configuration. For example, the WTRU may send a SR in accordance with the SR configuration for indicating SL transmission failure for the DRB when the DRB is in the limited survival time QoS state based on determining that the at least one TB including data of the DRB that was transmitted in accordance with the limited survival time QoS state has failed. The WTRU may send another (e.g., new) transmission for the DRB in accordance with the limited survival time QoS state. During a ST state, the WTRU may perform one or more of the following. During the (e.g., limited) survival time state, among the plurality of available grants, the WTRU may select a grant (e.g., at least one grant) for the transmission of another (e.g., new) transmission corresponding to at least one of: a grant having a highest reliability for MCS of a plurality of available grants, and/or the grant(s) (pre)configured to be used (e.g., conditionally) in ST state (e.g., a configured grant associated with the limited survival QoS state, and/or a plurality of configured grants used for duplication of the other new transmission). For example, during a ST state, the WTRU may duplicate TB transmissions on one or more (e.g., multiple) configured grants (CGs).

CSI may include one or more of the following: channel quality index (CQI), rank indicator (RI), precoding matrix index (PMI), an L1 channel measurement (e.g., RSRP, such as L1-RSRP, or signal to interference plus noise ratio (SINR)), CSI-RS resource indicator (CRI), SS/physical broadcast channel (PBCH) block resource indicator (SSBRI), layer indicator (LI), and/or one or more (e.g., any) other measurement quantity measured by the WTRU from the configured CSI-RS and/or SS/PBCH block.

Channel conditions may include one or more (e.g., any) conditions relating to the state of the radio/channel.

The WTRU may determine a state of the radio/channel from one or more of: a WTRU measurement (e.g., L1/SINR/RSRP, CQI/MCS, channel occupancy, RSSI, power headroom, exposure headroom, and/or the like), L3/mobility-based measurements (e.g., RSRP, reference signal received quality (RSRQ), and/or the like), an RLM state, channel availability in an unlicensed spectrum (e.g., whether the channel is occupied based on a determination of an LBT procedure or whether the channel is deemed to have experienced a consistent LBT failure), and/or measurements associated with SL channels (e.g., CR, CBR, SCI-RSRP, SL-CQI, and/or the like).

A property of scheduling information (e.g., an uplink grant or a downlink assignment) may include one or more of the following: a frequency allocation; an aspect of time allocation, such as a duration; a priority; a modulation and coding scheme; a transport block size; one or more (e.g., a number of) spatial layers; one or more (e.g., a number of) transport blocks to be carried; a transmission configuration indicator (TCI) state and/or scheduling request indicator (SRI); one or more (e.g., a number of) repetitions; and/or whether the grant is a configured grant type 1, type 2 or a dynamic grant.

An indication by DCI, and/or an indication, may include one or more of: an explicit indication by a DCI field and/or by RNTI used to mask CRC of the physical downlink control channel (PDCCH); an implicit indication by a property (e.g., a DCI format, a DCI size, a CORESET or search space, an aggregation level, an identity of first control channel resource (e.g., index of first CCE) for a DCI, in which the mapping between the property and the value may be signaled by RRC and/or MAC, and/or the like); and/or an explicit indication by a DL MAC CE.

One or more (e.g., some) of the embodiments and/or methods described herein may be exemplified based on transmissions and/or delivery of URLLC and/or extended reality (XR) services. The embodiments and/or methods described herein may not be limited to such scenarios, systems, and/or services; the embodiments and/or methods described herein may be applicable to one or more (e.g., any) type(s) of transmissions and/or services, including but not limited to Cloud gaming, loT/MTC, industrial use cases, vehicle to everything (V2X), multicast broadcast multimedia services (MBMS), and/or the like.

In examples, triggering of survival state may be (e.g., commonly) observed to boost QoS and/or reliability. The survival state may be triggered by one or more (e.g., any) of the QoS triggers as discussed herein. Embodiments described herein for boosting reliability and/or QoS requirement attainment on Sidelink may be applied for one or more (e.g., various) types of traffic, services, and/or DRBs. For example, the embodiments for boosting reliability and/or QoS requirement attainment on Sidelink may be applied for one or more (e.g., various) types of traffic, services, and/or DRBs even if the underlying application is not configured with survival time requirement and/or if DRBs are not configured with survival time requirement.

In examples, the WTRU may be configured with aspects and conditions for ST triggering. The WTRU may determine to apply the methods for ST state triggering and recovery (e.g., as described herein) as a function of a configuration per WTRU and/or per DRB. For example, the WTRU may be configured with one or more DRBs for which survival time QoS requirement, or a different latency critical QoS requirement, is applicable. The WTRU may activate one or more (e.g., any) of the added reliability embodiments and/or methods described herein, for example, upon triggering and/or entry of survival time state. The WTRU may de-activate one or more (e.g., any) of the added reliability embodiments and/or methods described herein, for example, upon exiting the survival time state. The WTRU may apply ST triggering and recovery for TBs that include data from at least one DRB configured with such low-latency QoS requirement. The WTRU may apply ST triggering and recovery if the WTRU is configured by RRC with a given low-latency and/or high reliability QoS requirement, at least one DRB is configured with such QoS requirement, and/or if the WTRU is of a certain WTRU capability. The WTRU may apply ST triggering and recovery dependent on the peer WTRU type, peer WTRU capability, and/or whether the peer WTRU supports reception of data of such low-latency and/or high reliability QoS requirement. The WTRU may apply ST triggering and recovery for TBs that include data from at least one DRB configured duplication. Reliability embodiments described herein may depend on, and/or (e.g., only) be applicable to a specific trigger (e.g., dropping due to CR, measuring a high CBR level, dropping due to an overlapping Uu transmission, and/or the like).

In examples, the WTRU may be configured to trigger a ST state during SL transmission. Triggers may be common for both SL modes 1 and 2. One trigger may occur by TB drop. The WTRU may trigger ST state as a result of dropping a SL transmission. Dropping the SL transmission may occur as a result of prioritization decisions. Dropping the SL transmission may occur as a result of a pre-emption decision. For example, the WTRU may drop and/or delay a SL transmission as a result of prioritizing a Uu transmission over a SL transmission. For instance, if at the time of a SL grant, the WTRU prioritizes a Uu transmission over a SL transmission, in the case where the WTRU is unable to transmit both Uu and SL together, the WTRU may trigger ST state. In examples, the WTRU may drop and/or delay a SL transmission as a result of prioritizing a higher priority transmission and/or reception (e.g., transmission/reception of PSFCH). For instance, if at the time of a SL grant, the WTRU prioritizes reception of PSFCH and does not perform transmission, the WTRU may trigger the ST state.

A trigger may occur by an LBT failure determination. The WTRU may trigger a ST state upon failing to transmit on SL resource and/or failing to reserve a SL resource. For example, the WTRU may trigger a ST state upon failing to transmit on SL resource and/or failing to reserve a SL resource caused by determination of an LBT failure, The WTRU may determine that LBT has failed based on reception of an indication from the physical layer indicating a SL transmission has failed LBT. The WTRU may determine that a LBT failed (e.g., only) after an LBT reference point in time has passed and/or a LBT/CCA stop condition is met. A reference point in time may be based on a stop condition. For example, the stop condition may occur by the end of CCA period. The stop condition may (e.g., additionally or alternatively) be based on receiving an indication of LBT failure from PHY layer. In examples, the stop condition may be based on receiving an indication of LBT failure from PHY layer if the failure indication provides more information regarding the SL resource on which the failure happened. For example, if the indication provides that an LBT failure happened on an RB set matching the reserved SL resource, the WTRU may trigger ST state and/or may determine that an LBT failure has occurred. The WTRU may trigger a ST state upon failure to access the channel before a reserved SL resource and/or within a period for the transmission. For example, an LBT stop condition may include a resource selection window of which the end of the window is based on the packet delay budget (PDB) of the TB.

A trigger may occur by failure to transmit a message, NACK, and/or failure to receive HARQ feedback. The WTRU may determine to trigger a survival time state and/or activate one or more (e.g., any) of the added reliability embodiments described herein upon determining one or more transmissions on SL have failed, and/or related control information for a TB with ST and/or low latency QoS requirement (e.g., failure to transmit HARQ feedback and/or SCI). A failed transmission may include a SL data transmission including at least one DRB configured with a low-latency and/or survival time QoS requirement. The WTRU may determine a failure based on one or more of the following: receiving and/or determining a HARQ-ACK value as NACK for the transmission; not receiving expected HARQ feedback for the transmission at the expected time; not receiving control information (e.g., SCI or PSFCH) from the peer WTRU to which data was transmitted; and/or receiving control information and/or SCI indicating that the transport block was not successfully decoded.

The WTRU may trigger a survival time state, apply one or more of the added reliability embodiments and/or methods described herein, and/or determine that a transmission has failed if at least one or more of the following is satisfied: one or more (e.g., all) PDCP PDUs part of the same higher layer application SDU have failed; at least one PDCP PDU part of the same SDU has failed; a certain anchor PDU from a PDU set has failed; one or more (e.g., a number of) x consecutive transport blocks, PDCH SDUs, and/or PDCP PDUs have failed in a row or while a timer is running; the transmission includes at least one DRB configured with survival time and/or low-latency QoS requirement; not receiving control information, data, and/or an expected period TB and/or SCI from the peer WTRU to which data was transmitted; a reception of signalling and/or an indication (e.g., by DCI and/or MAC CE) from the gNB; expiration of a timer since the transmission of the transport block that is started by the transmitting WTRU; failing to transmit HARQ feedback and/or SCI for a received TB from a peer WTRU, in which the TB may include data of low-latency and/or a survival time requirement; and dropping HARQ feedback and/or SCI for a received TB from a peer WTRU. For the scenario in which one or more (e.g., a number of) x consecutive transport blocks, PDCH SDUs, or PDCP PDUs have failed in a row or while a timer is running, x may be configured by RRC. For example, if one HARQ NACK is configured to trigger ST, the WTRU may trigger ST if HARQ feedback/PSFCH reception was dropped. In examples, if more than one NACK/failure is configured to trigger ST, the WTRU may wait for another PFSCH occasion and/or trigger ST after x consecutive dropped PUSCHs and/or a NACK is received. For the cases in which HARQ feedback and/or SCI for a received TB from a peer WTRU is dropped, the TB may include data of low-latency and/or a survival time requirement, where the dropping may be based on: intra-WTRU prioritization, deprioritization/pre-emption by another Uu transmission, deprioritization/pre-emption by another SL transmission, and/or LBT failure.

The WTRU may trigger a survival time state, apply one or more of the added reliability embodiments and/or methods as described herein, and/or determine that a transmission has failed if the WTRU has failed to receive HARQ feedback from the peer WTRU. For instance, the WTRU may determine that a transmission has failed if the HARQ PSFCH is not received and/or delayed beyond a configured and/or predetermined period since the TB transmission (e.g., where the feedback hasn't been received within a ST-related timer, a shared channel occupancy time (COT), a maximum COT duration, and/or an expected feedback (FB) arrival time).

A WTRU may trigger survival time state, apply one or more of the added reliability embodiments and/or methods, as described herein, and/or determine that a transmission has failed if the WTRU determines that HARQ PSFCH reception was dropped due to overlap with another UL transmission and/or SL transmission (e.g., an LTE SL transmission and/or another SL transmission of higher priority at the peer WTRU). This may cause the WTRU to (e.g., either) trigger ST and/or enter the pre-emptive action for added reliability (e.g., prior to determining a failed transmission with certainty).

A pre-emptive trigger may be based on measurements of channel conditions. The WTRU may determine to trigger survival time state and/or activate one or more (e.g., any) of the added reliability embodiments, as described herein, upon making a measurement of certain channel condition above or below a configured threshold. A measurement may be related to a shared channel/SL resource and/or related to the specific channel conditions between the tx and peer WTRUs.

A WTRU may determine to trigger survival time state after making an RSRP measurement on a given SL resource (e.g., a mode 2 resource pool) above a threshold. The RSRP may be associated with measuring SCIs from other WTRUs sharing the resource. The WTRU may trigger a survival time state upon performing a measurement on a shared channel (e.g., a sidelink channel operating on unlicensed spectrum) above a threshold. For example, the WTRU may trigger a ST state upon measuring RSSI and/or channel occupancy (CO) above a certain configured threshold.

A WTRU may trigger a ST state after measuring a link quality metric and/or channel condition below or above a configured threshold. The link may be between the tx WTRU and the peer WTRU to which a TB with ST and/or low latency QoS data is transmitted. For example, the WTRU may trigger a ST state if the measured CQI for the link between the WTRUs is below a certain configured threshold. The WTRU may trigger a ST state if the measured L1-RSRP, BLER, or L1-SINR for the link between the WTRUs is below a certain configured threshold. The threshold may be configured by RRC configuration or reconfiguration signalling.

A WTRU may trigger a ST state based on the measurement pertaining to a sidelink between the WTRU and a peer WTRU. The WTRU may receive a RSRP measurement from a peer WTRU and determine a corresponding path loss. The WTRU may trigger a ST state when the determined path loss may be below a configured and/or preconfigured threshold. In examples, the WTRU may determine a transmit power based on the determined path loss. The WTRU may trigger a ST state when the determined SL transmit power may exceed a preconfigured and/or configured maximum power.

A WTRU may trigger a ST state based on the resource selection information (e.g., Inter-WTRU Coordination (IUC) information) received from a peer WTRU. For example, the WTRU may be configured to receive a non-preferred resource set from a peer WTRU and (e.g., determine to) trigger ST state based on the received non-preferred resource set. A non-preferred resource set may include resources in which the peer WTRU may not be able to receive a SL transmission from the WTRU. The WTRU may trigger a ST state when the number of received non-preferred resources may exceed a preconfigured and/or configured threshold. The preconfigured and/or configured threshold may be indicated as a ratio of the number of the non-preferred resources to the total resources to be selected in a resource selection window. In examples, the WTRU may receive one or more conflict indications in a PSFCH specific to resources reserved by the WTRU. The conflict indication may indicate that the reserved resources overlap with resources reserved by other WTRUs. The WTRU may trigger a ST state when the WTRU receives one or more conflict indications. The WTRU may perform resource re-selection as the WTRU enters ST state.

A WTRU may be configured with low-latency QoS requirements and other triggers caused by QoS requirements other than ST. Other QoS conditions that can cause the WTRU to trigger a ST state (e.g., PDB related triggers, triggers occurring for failure to transmit certain PDU from a PDU set, triggers occurring for out of order SDU sequence number (SN) are described herein. The WTRU may trigger a survival time state, apply one or more of the added reliability embodiments and/or methods, as described herein, upon satisfying one or more (e.g., any) of the following QoS conditions: arrival of data of a certain priority; a PDB remaining time; a time since data arrival; a missing PDU from a PDU set; receiving an acknowledgement for reception of an out of order PDCP SN from the peer WTRU; an intra-WTRU prioritization between PDUs of different priorities; triggering of a BSR or SR caused by data arrival from DRBs configured with low-latency QoS or ST requirements; a configuration of at least one SL DRB with survival time or a low-latency QoS parameter or priority; and/or reception of DL data from a certain priority or from a DL DRB associated with a SL DRB. With respect to the arrival of data of a certain priority, the WTRU may be configured with a priority index per LCH or DRB. Upon arrival of data of high priority index or a certain priority index, the WTRU may trigger ST. With respect to the PDB remaining time, the WTRU may trigger ST if the remaining time in the packet's PDB is less than a certain threshold, expired, or about to expire. With respect to the time since data arrival, the WTRU may be configured to trigger ST if the time since data arrival at the WTRU buffer is less than or above a configured and/or predefined threshold (e.g., relating to the ST value). With respect to a missing PDU from a PDU set, the WTRU may trigger a ST state upon determining that a certain PDU (e.g., an anchor PDU) from a PDU set was not transmitted successfully, was not acknowledged by the peer WTRU, and/or was not received from higher layers. The WTRU may be configured or predefined to determine which PDUs within a PDU set is an anchor DPU (e.g., a PDU associated within certain frames of a video stream). With respect to receiving an acknowledgement for reception of an out of order PDCP SN from the peer WTRU, if the WTRU receives successful acknowledgment of reception of PDCP SN 1, 2, then 4, for example, the WTRU may trigger a ST state because SN 3 was not acknowledged. In examples, the WTRU may trigger the ST state if the SN 3 was not received from higher layers within the WTRU. With respect to intra-WTRU prioritization between PDUs of different priorities, the WTRU may trigger a ST state upon dropping PDU due to intra-WTRU prioritization with a higher priority HARQ-ACK and/or higher priority SL PDU. One or more of the conditions described herein may be used to characterize low-latency QoS requirement.

One or more triggers may be related to SL mode 2 transmission. A WTRU may be configured with CBR based triggers. The WTRU may trigger a ST state following a transmission, based on a condition related to measured CBR while operating in mode 2. The WTRU may trigger the ST stated based on the condition related to the CBR measured at the time of transmission, while operating in mode 2. For example, the WTRU may trigger a ST state if the measured CBR is above a configured threshold. In examples, the WTRU may trigger a ST state if the measured CBR changes (e.g., increases) by a configured amount. In examples, the WTRU may trigger a ST state if the transmission results in triggering congestion control, such as, but not limited to, reducing the transmit power, reducing the number of resources, changing the MCR, the QoS parameter of minimum communication range, and/or the like, compared to the previous transmission. Additionally or alternatively, the WTRU may trigger ST state if the measured CBR satisfies a condition for a period of time. For example, if the measured CBR stays above a threshold for a period of time, the WTRU may trigger ST state following this period of time. The WTRU may maintain a ST state for a preconfigured period of time, for a single or predefined/preconfigured number of transmissions, and/or until an additional condition related to CBR (e.g., CBR falls below a threshold) is met.

One or more triggers may be related to CR based triggers. A WTRU may be configured with CR based triggers. The WTRU may trigger a ST state, following a transmission, based on a condition related to the measured CR. The WTRU may trigger the ST state based on the condition related to the CR measured at the time of that transmission. For example, the WTRU may trigger a ST state if the CR measured is above a threshold. For example, the WTRU may trigger a ST state if the CR reaches the CR limit and the WTRU chooses to drop a transmission as a result. For example, the WTRU may trigger a ST state for one or more (e.g., every) transmissions following each dropped transmission resulting from reaching the CR limit. For example, the WTRU may maintain a ST state as long as the CR is above a threshold. For example, the WTRU may maintain a ST state as long as the condition related to CR that initiated ST state is met.

One or more triggers may be based on pre-emption. A WTRU may be configured with pre-emption-based triggers. The WTRU may trigger a ST state following a pre-emption decision. For example, the WTRU may trigger a ST state if the WTRU pre-empts a selected resource as a result of sensing results. The sensing results may be sensing results of the WTRU, and/or based on sensing information provided by another WTRU. For example, if the WTRU has already reserved a resource for transmission and performs reselection due to pre-emption, the WTRU may trigger a ST state. Additionally or alternatively, the WTRU may trigger a ST state following a trigger to perform re-evaluation. For instance, the WTRU may trigger a re-evaluation following an initial resource selection, and/or the WTRU may trigger a ST state following the decision to perform re-evaluation. The WTRU may trigger a ST state following pre-emption and/or a re-evaluation based on one or more (e.g., further) conditions related to the reselected resource. For instance, the WTRU may trigger a ST state following pre-emption and/or re-evaluation (e.g., only) when the reselected resource occurs later in time compared to the initially selected resource. For example, the WTRU may trigger the ST state following pre-emption and/or re-evaluation (e.g., only) when the reselected resource occurs later in time by one or more (e.g., a number of) slots.

One or more triggers may be sensing-based. A WTRU may be configured with sensing-based triggers. The WTRU may trigger a ST state following a condition associated to sensing results, a sensing mechanism, and/or similar. In examples, a ST state may be triggered by a condition related to the number of times the RSRP threshold was increased by 3 dB to achieve the required available resources. For example, the WTRU may trigger a ST state if the WTRU performs resource selection, and the selected resources are obtained after needing to increase the threshold RSRP by 3 dB to achieve x % of the available resources. In examples, a ST state may be triggered by a condition related to the number of available resources from which the WTRU performs random selection. For example, the WTRU may trigger a ST state if the WTRU performs resource selection, and the selected resources are obtained after the amount of available resources when performing random selection is less than y %. In examples, a ST state may be triggered by a condition related to the SCI RSRP observed in the resource pool, and/or a number of resources having a high SCI RSRP. For example, the WTRU may trigger a ST state if the WTRU performs resource selection, and the selected resources are obtained such that the pool of available resources has at least z % of the available resources having SCI RSRP from another WTRU above a preconfigured threshold. In examples, a ST state may be based on the type of sensing performed. For example, a ST state may be used in one or more (e.g., all) cases for a WTRU that uses random selection in a resource pool, and/or uses partial sensing in a resource pool.

One or more triggers may be related to SL mode 1 transmission. Triggers may be based on reception of DL indication on Uu. A WTRU may be configured with a trigger based on reception of a DL indication on Uu. The WTRU may trigger survival time state, apply one or more of the added reliability embodiments and/or methods, as described herein, upon reception of an indication from the network on Uu indicating that the WTRU should enter a ST state. The WTRU may be configured to trigger a ST state (e.g., implicitly) from reception of such indication. The WTRU may be configured to trigger the ST state (e.g., implicitly) from the reception of such indication even if the indication does not provide an explicit indication to enter the ST state. The network (NW) may be aware of an issue with the peer WTRU, for example, due to reporting the peer WTRU has provided to the NW. The indication may be in the form of one or more of the following: an indication by DCI as described herein; an indication determined by the WTRU as a function of a property from the scheduling as described herein; a reception of PDCCH; a reception of a DCI; a reception of a dynamic grant; an activation of a given CG or SPS resource; a reception of a grant; a reception of a DL MAC CE indicating ST entry; and/or a reception of a certain RRC message and/or an RRC reconfiguration for SL resources. With respect to the indication provided in the reception of PDCCH, the indication may be provided on a certain coreset and/or search space that may be associated with higher priority transmission and/or scheduling. With respect to the indication provided in the reception of the DCI, the indication may provided with high priority index indicated. With respect to the indication provided in the reception of dynamic grant (e.g., a SL DG), the indication may be provided if the dynamic grant is from a certain subset of HARQ processes. For example, the WTRU may trigger a ST state upon reception of a dynamic grant for retransmission of the TB with ST and/or low-latency QoS data multiplexed. In examples, the WTRU may be configured with a pool of HARQ processed associated with higher priority transmissions or with a certain priority index. With respect to the indication provided in an activation of a given CG or SPS resource, the WTRU may trigger a ST state upon reception of signalling activating a type-2 CG associated with high priority index. In examples, the WTRU may trigger a ST state upon reception of signalling activating a type-2 CG that is configured to be (e.g., conditionally) used in ST state (e.g., only). With respect to the indication provided in reception of grant (e.g., a SL DG and/or a CG), the indication may be provided if the dynamic grant is signalled and/or configured with a certain priority index (e.g., high priority, a priority index 1 or 0). With respect to the indication provided in a reception of a certain RRC message or an RRC reconfiguration for SL resources, for example, the WTRU may receive an RRC reconfiguration outlining a change of LCH and/or DRB priorities that are configured with ST and/or low-latency QoS requirements.

Methods for added reliability after ST triggering are described herein. A WTRU may be configured for added reliability after ST triggering. For instance, the WTRU may be configured for added reliability for both SL modes 1 and 2.

A WTRU may be configured for an adjustment of TB priority. For example, the WTRU may achieve a ST state by adjusting transmission priority and/or similar. In examples, the WTRU may increase the priority of a TB temporarily when performing SL transmission. For instance, the WTRU may use a higher priority (or use priority 1) during transmission in SCI. Additionally or alternatively, the WTRU may determine (e.g., assume) a higher logical channel priority than configured (e.g., use priority 1) when performing operations at the MAC layer (e.g., LCP, LBT, sensing, and/or the like). In examples, the WTRU may change one or more rules for UL/SL prioritization. For example, the WTRU may change one or more rules for UL/SL prioritization for a period of time. For instance, the WTRU may perform SL transmissions instead of Uu transmissions even when a Uu transmission is prioritized.

A WTRU may be configured for an adjustment of transmission parameters and/or resources after LBT failure. Upon triggering a ST state and/or during the ST state, the WTRU may perform one or more of the following: transmitting and/or retransmitting a TB on a different RB set; attempting LBT on a plurality of RB sets to transmit TB duplicates on a plurality of RB sets; attempting LBT on a plurality of RB sets to a single TB on an RB sets on which LBT is successful; and/or transmitting and/or retransmitting a TB with a short LBT and/or no LBT configuration. The WTRU may determine whether an LBT is successful or failed using one or more (e.g., any) of the methods as described herein. Upon triggering a ST state and/or during the ST state, the WTRU may perform one or more (e.g., any) of the procedures described herein based on the WTRU being conditioned on having a ST state triggered by an LBT failure.

A WTRU may be configured for an adjustment of PHY transmission parameters. Upon triggering a ST state and/or during a ST state, the WTRU may perform one or more of the following: changing and/or increasing the transmit power; a MCS/coding rate; and/or a diversity configuration using more antenna ports. With respect to changing or increasing the transmit power, the WTRU may be configured with an alternative value(s) for transmit power to use in a ST state. The WTRU may be configured with a tx power offset, in which the WTRU may increase the tx power by such delta during ST state and/or after each retransmission. With respect to the MCS/coding rate, the WTRU may be configured with an alternative value(s) for MCS to use in the ST state. The WTRU may be configured with a MCS offset, in which the WTRU increases the MCS reliability during the ST state and/or after each retransmission. With respect to a diversity configuration using more antenna ports, the WTRU may be configured with an alternative value(s) for the number of antenna ports and/or elements to use in the ST state. The WTRU may use more antenna ports/elements and/or an alternative configuration for beamforming upon entering the ST state and/or after each retransmission.

A WTRU may be configured for an adjustment of repetition and duplication. The WTRU may activate autonomous blind retransmissions/repetition, and/or increase the number of autonomous repetitions upon triggering ST state and/or during ST state. The WTRU may duplicate TB transmissions on one or more (e.g., multiple) SL resources (e.g., CGs or resource pools) upon triggering a ST state and/or during the ST state.

One or more stop conditions may be associated with added reliability. A WTRU may be configured with one or more stop conditions for added reliability. The WTRU may be predefined and/or configured with one or more criteria to exit an ST state and/or to stop using the added reliability embodiments and/or methods, as described herein, including one or more of the following: reception of ACK for the same or next TB; reception of SCI; expiration of a timer; channel measurement based; and/or reception of an indication from the network to exit a ST state.

With respect to reception of ACK for the same or next TB, a WTRU may exit a ST state upon receiving a HARQ ACK (e.g., on PSFCH), receiving a configured or predefined number of HARQ ACKs consecutively (e.g., for in-sequence TBs/PDUs), and/or determining an ACK implicitly from an expiry of a timer. The WTRU may exit the ST state (e.g., only) if the ST state was triggered by NACK reception and/or determination.

With respect to reception of SCI, the WTRU may exit the ST state upon reception of SCI from the peer WTRU. The reception of SCI from the peer WTRU may indicate the reception of the transmitted PDU. The WTRU may exit the ST state (e.g., only) if the ST state was triggered by NACK reception or determination.

With respect to the expiration of a timer (e.g., a survival time related timer), the WTRU may start a timer upon entering the ST state, and upon expiration of such timer, the WTRU may exit the ST state and stop using the reliability embodiments and/or methods as described herein. Such timer may be stopped when the survival time limit set by higher layers has expired or elapsed.

With respect to exiting the ST state based on channel measurements, the WTRU may exit the ST state when a channel measurement is made below or above a certain configured threshold. The WTRU may exit ST state when a channel measurement is made below or above a certain configured threshold (e.g., only) if a ST state was triggered by channel measurements and/or by preemptive triggers for added reliability in absence of NACK certainty. For example, the WTRU may exit ST state if: a CR is lower than a threshold; a CBR is lower than a threshold; a link quality between peers is above a threshold (e.g., based on CSI-report and/or CQI); and/or a RSRP is less than or greater than a threshold.

With respect to a reception of an indication from the network to exit ST state, one or more (e.g., any) of the indication examples as described herein may be applicable for exiting a ST state. Exiting the ST state when receiving an indication from a network may be applicable (e.g., only) if the ST state was triggered by gNB indication. For example, the WTRU may exit the ST state upon CG de-activation and/or a reconfiguration of SL resource.

A WTRU may be configured with added reliability for mode 2. The WTRU may be configured for an adjustment of TB priority. The WTRU may be configured in a ST state by adjusting transmission priority, and/or similar in the case of mode 2 transmissions. In examples, the WTRU may increase the priority of a TB temporarily when performing resource selection. For instance, the WTRU may use a higher priority (or use priority 1) during determination of available resources. In examples, the WTRU may temporarily disable congestion control and/or a CR limit during a ST state. For instance, the WTRU may not reduce transmission parameters according to CBR, and/or may determine (e.g., assume) the lowest CBR range when selecting transmission parameters. A WTRU may not limit the CR, and/or may determine (e.g., assume) a higher CR limit during a ST state. In examples, a WTRU may trigger resource selection and/or reselection when entering into a ST state, and/or may change the criteria associated with the resource selection to obtain resources that have less interference from other WTRUs. For instance, the SCI RSRP, used for determining available resources may be lower or fewer than x % of resource availability, may be accepted to perform random selection in better quality resources. For example, better quality resources may refer to meaning less interference (e.g., which can be measured by having SCI RSRP x dB less than a usual threshold outside the ST state and/or the percentage of resources available—without interference—is x percent higher than outside of the ST state). “x” may be a configured threshold value that may be configured by RRC configuration signalling and/or reconfiguration signalling. In examples, the WTRU may transmit in a different resource pool during the ST state. For example, the WTRU may use the exceptional resource pool. For example, the WTRU may use a resource pool that allows full sensing, if ST state is triggered while the WTRU is performing random selection in a pool.

A WTRU may be configured for an adjustment of transmission resource selection. In an ST state, the WTRU may adjust the resource selection window for a mode 2 sidelink resource. The WTRU may start the selection window after the triggering of a ST state, and/or upon reception of a HARQ NACK for a TB transmitted with ST and/or low latency QoS requirement. The WTRU may adjust the maximum window size such that the remaining delay budget of the next TB transmitted falls within the expiration of the ST timer or remaining PDB. The WTRU may adjust the maximum window size such that the resource selection window (RSW) and the transmission time ends prior to the expiration of the delay budget. The delay budget may be determined from the remaining time in the ST timer, remaining time within the PDB, and/or remaining time within the higher layer application survival time.

In a ST state, the WTRU may select a resource even if congestion level is higher than a (e.g., typical) threshold (e.g., in legacy configurations). The WTRU may select the resource on the condition of receiving one or more (e.g., a number of) NACK(s). In examples, the WTRU may be configured with an additional second RSRP threshold and/or an offset, in which the WTRU may (e.g., still) select the SL resource. The WRTU may select the SL resource even if RSRP is higher than a legacy first threshold and RSRP is lower than the second additional threshold. The second threshold may be determined based on adding an offset to the first threshold. The WTRU may increase the value of the second threshold and/or add an offset to the threshold after each NACK received and/or determined in a row, and/or while a ST timer is running. The WTRU may neglect the traffic priority in the measured resource and transmit regardless of such priority if the ST state is trigged and/or consider its priority higher than the traffic priority in the measured resource.

The WTRU may be configured with a plurality of mode 2 resource pools. Each resource pool may be configured with a priority index, an MCS, a transmission power, (e.g., a determination of) whether such resource pool may be used during and/or outside of the ST state, and/or an alternative CR and/or CBR threshold. During the ST state, among the plurality of available grants, the WTRU may select a resource pool for the transmission and/or retransmission as: the pool with highest reliability MCS; the pool configured with the highest transmit power; the pool with smallest measured CBR, CR, and/or RSRP associated with other WTRUs/traffic on such resource; the pool preconfigured to be used (e.g., conditionally) in survival time state; and/or the pool with highest configured priority index and/or reliability level. The pool with highest reliability MCS may be, for example, the pool with the lowest spectral efficiency that can accommodate the SDU without segmentation.

Upon triggering and/or during a ST state, the WTRU may use a subset of available resource pools. For example, the WTRU may transmit data on resource pools configured for conditional use (e.g., only) during ST state. For instance, upon reception and/or determination of a HARQ NACK, the WTRU may switch to using a different resource pool and/or a different RB set that is configured to be used during the ST state. The WTRU may duplicate a TB transmission on one or more (e.g., multiple) resource pools during the ST state. For example, the WTRU may duplicate the TB transmission on one or more (e.g., multiple) resource pools during the ST state, in which a duplicate may transmitted on a subset of resource pools (e.g., those resources configured to be (e.g., conditionally) used during a ST state).

A WTRU may be configured with pre-emptive added reliability based on measurements and/or prior to ST state triggering. The WTRU may exclude selection of a SL resources (e.g., a mode 2 resource pool or pool on a given RB set) for TB transmissions including data associated with ST and/or low-latency QoS requirement if a measurement of a channel condition is above or below a configured threshold(s). For example, the WTRU may exclude resources with a CR, CBR, and/or SCI-RSRP measured above a configured threshold. The threshold(s) may be determined based on adding a positive or a negative offset to existing thresholds for resource selection (e.g., for RSRP associated with SCI transmissions from other WTRUs sharing the resource).

The WTRU may exclude selection of a SL resources (e.g., a mode 2 resource pool or pool on a given RB set) for TB transmissions including data associated with a ST and/or low-latency QoS requirement if a pre-emption and/or a de-prioritization event occurred on such resource. The WTRU may exclude the selection of the SL resources based on a condition that the de-prioritization event involved data from the same priority and/or data with an ST and/or low-latency QoS requirement configured. Upon dropping an ST related transmission due to pre-emption or prioritization of a different Uu and/or SL transmission, the WTRU may exclude such resource for the transmission and/or retransmission of the dropped transmission.

A WTRU may rank the remaining available resources based on a measured quality metric of each available resource. The WTRU may rank the remaining available resources based on the measured quality metric of each available resource after the above-mentioned resource exclusions in Mode 2 resource selection to further improve reliability. In examples, the WTRU may rank the available resources in the order of measured RSRP and/or RSSI and determine a set of resources with the highest RSRP and/or RSSI measurement for resource selection.

A WTRU may request a peer WTRU to provide Inter-WTRU Coordination (IUC) information for resource selection. In examples, the WTRU may request a peer WTRU to provide a preferred resource set including the resources that the peer WTRU may prefer to receive from the transmissions of the WTRU. The WTRU may perform resource selection for a transmission to a peer WTRU within the received preferred resources.

A WTRU may be configured for added reliability for mode 1. A WTRU may be configured to perform an adjustment of transmission resource selection. The WTRU may be configured with a plurality of configured grants for SL mode 1 transmission. Each configured grant may be configured with one or more of: a priority index, an MCS, a transmission power, and/or a determination of whether such grant can be used during and/or outside of the ST state.

During the ST state, among the plurality of available grants, the WTRU may select a grant for the transmission of another (e.g., new) transmission as: the grant with highest reliability MCS (e.g., lowest spectral efficiency that can accommodate the SDU without segmentation); the grant configured with the highest transmit power; the grant preconfigured to be used (e.g., conditionally) in survival time state; and/or the grant with highest configured priority index and/or reliability level.

The WTRU may neglect a CG occasion among the plurality of available CG occasions. For instance, the WTRU may skip, drop, and/or not transmit on the CG occasion. The time constraint may be related to the remaining time in the survival time timer. The WTRU may be configured to neglect the CG occasion among the plurality of available CG occasions if such occasion is not reliable enough and/or may not meet the transmission duration constraints of the remaining survival time timer and/or PDB. That is, the WTRU may use a CG occasion that meets reliability constraints and/or time constraints. The WTRU may be configured to neglect the CG occasion even if it is the first occurring CG occasion.

Upon triggering and/or during the ST state, the WTRU may use a subset of available configured grants. For example, the WTRU may (e.g., only) transmit data on configured grants configured for conditional use (e.g., only) during ST state. For instance, upon reception and/or determination of a HARQ NACK, the WTRU may switch to using a different CG configuration that is configured to be used during the ST state. The WTRU may duplicate a TB transmission on one or more (e.g., multiple) CGs during the ST state. For example, the WTRU may duplicate a TB transmission on one or more (e.g., multiple) CGs during the ST state in which a duplicate TB transmission may be transmitted on a subset of CGs (e.g., those CGs configured to be (e.g., conditionally) used during ST state).

Upon reception of a dynamic grant, a dynamic grant triggering ST state entry (e.g., as described herein), and/or triggering of a ST state, the WTRU may prioritize multiplexing data from DRBs/LCHs configured with ST and/or low-latency requirement on such DG. The WTRU may prioritize multiplexing data from DRBs/LCHs configured with ST and/or low-latency requirement on such DG if another LCH has a higher LCP priority and such LCH is not configured with ST requirement. Upon activation of a CG configured for conditional use during a ST state and/or a CG activation triggering ST state entry, the WTRU may prioritize the transmission of transport blocks including data from LCHs/DRBs configured with ST and/or low-latency QoS requirements. Upon activation of CG configured for conditional use during ST state and/or a CG activation triggering ST state entry, the WTRU may prioritize the retransmission of a TB including data from LCHs/DRBs configured with ST and/or low-latency QoS requirements over another (e.g., new) transmission without such data/QoS requirement and/or over another retransmission without such data/QoS requirement.

A WTRU may be configured to report a ST trigger and/or related measurements. A WTRU may be configured for precautionary reporting of channel conditions to the network. The WTRU may report to the gNB the cause and/or the trigger that caused the ST state entry and/or ST state triggering. The WTRU may report to the gNB channel condition measurements that caused the ST state entry and/or pre-emptive added reliability. For example, the WTRU may report one or more of a dropped transmission due to overlap with another Uu and/or SL transmission, a dropped transmission due to CR, a failure to transmit HARQ feedback and/or SCI to a peer WTRU involved with ST and/or low latency QoS, and/or a failure to transmit on a SL resource. The WTRU may report (e.g., measurement) quantities associated with ST state triggering. In examples, a WTRU may report a channel access failure (e.g., a Type 1 channel access) in a RB set/sub-band/channel to a gNB. The WTRU may report the channel access failure in the RB set/sub-band/channel to the gNB when the WTRU may fail to access the channel in a resource selection window. The WTRU may include RSSI values and/or CO measured in LBT sensing with the resource selection window. In examples, when the WTRU fails a channel access in Mode 1, the WTRU may be triggered to perform a measurement of CO/RSSI/RSRP/CBR of one or more (e.g., all) configured and/or preconfigured RB sets/sub-bands/channels and/or report the results to gNB to aid resource allocation by gNB in Mode 1.

A WTRU may (e.g., conditionally) report such events or measurements upon data arrival and/or transmission from a DRB configured for ST and/or low-latency QoS. The WTRU may report channel measurement (e.g., CR, CBR, RSSI, and/or CO) pre-emptively. For example, the WTRU may report the channel measurement if the measured value is below or above a configured threshold for reporting. In examples, the WTRU may start reporting channel condition measurements upon data arrival from a DRB and/or LCH configured with a certain ST and/or low-latency QoS requirement. The WTRU may start reporting the channel condition measurement according to a configured periodicity. In The WTRU may start (e.g., periodically) reporting such events and/or measurements upon starting to evaluate at least one trigger as described herein.

A WTRU may be configured for reporting SL transmission failures to the network. The WTRU may report a ST state entry to the gNB, for example, if the WTRU is in coverage. For example, the WTRU may send a report, when in coverage, to the network, that includes an indication of a transmission failure, a channel busy ratio (CBR) being above a threshold, and/or a channel occupancy ratio (CR) being above a threshold. The WTRU may (e.g., also) report a ST state exit. Along with ST state reporting, the WTRU may report the cause of ST entry (e.g., the cause of the ST entry may be, for example, one of the triggers as described herein). The WTRU may report a transmission failure. For example, the WTRU may report a transmission failure if the transmission includes data from a DRB configured with ST and/or low-latency QoS and/or if the transmission is governed by low-latency QoS. For instance, the WTRU may report a HARQ NACK to the gNB on PUCCH and/or PUSCH upon determining and/or receiving NACK on PSFCH. In examples, the WTRU may report the HARQ NACK to the gNB on PUCCH and/or PUSCH upon not receiving feedback from the peer WTRU. The WTRU may report ST state entry to the gNB part of the PUSCH payload and/or a multiplexed MAC CE. The WTRU may indicate that the ST state is enabled and/or uses the added reliability embodiments as described herein. The WTRU may indicate the peer WTRU to which the transmission is intended.

In one or more cases, the WTRU may be configured with an SR configuration. The SR configuration may be used for reporting ST state entry and/or transmission failures associated with ST and/or low-latency QoS requirements, and/or for obtaining a SL resource suitable for transmitting and/or retransmitting data associated with a ST and/or low-latency QoS requirement. The WTRU may trigger another (e.g., new) SR upon triggering a ST state, failing a transmission associated with ST and/or low-latency QoS requirements, and/of if the available resources are not suitable (e.g., as described herein) to transmit and/or retransmit data payloads associated with ST and/or low-latency requirements (e.g., prior to the expiration of a ST timer). For example, not suitable resources may include one or more available resources that do not meet one or more QoS requirements (e.g., the duration and/or end time of the transmission exceeds remaining time in the ST timer, associated with high interference-based on SCI RSRP being greater than a threshold, for example-not meeting LCP restriction(s) of data to be transmitted, etc.). For such newly triggered SR, the WTRU may use the SR configuration (e.g., an associated PUCCH resources) configured for ST state reporting for the transmission of such SR. In examples, the WTRU may trigger another (e.g., new) SR if the available resource is not reliable enough to complete the transmission and/or retransmission of data associated with ST and/or low latency QoS. The WTRU may determine whether the available resource is reliable enough to complete the transmission and/or retransmission of data based on: the priority index associated with the available SL resource, a determination of whether the available SL resource is big enough to accommodate the whole SDU arrival, a determination of whether the SL resource has caused a failure and/or a ST state trigger, and/or a measured CR and/or CBR on the available SL resources being higher than configured threshold. For example, the determination of whether the available resource is big enough to accommodate the whole SDU arrival may include determining whether the whole SDU can fit in the resource without segmentation (e.g., number of data bits in the resource is greater than or equal to the number of bits of the SDU plus applicable subheaders inserted and control elements added in the transmission).

A WTRU may be configured for ST recovery based on failed transmission and/or failure to receive HARQ FB. The WTRU may be configured with one or more DRB for which survival time QoS requirement is applicable. The WTRU may determine that a transmission on a SL resource has failed and/or triggers a survival time state for increased transmission reliability. The WTRU may determine that the transmission on the SL resource has failed and/or triggers the survival time state based on one or more of the following: receiving a PSFCH and/or SCI indicating a failure from the peer WTRU; not receiving expected HARQ feedback for the transmission at the expected time; determining that the transmission includes at least one DRB configured with survival time and/or low-latency QoS requirement; dropping HARQ feedback and/or SCI for a received TB from a peer WTRU; and/or reception of a DL indication from the gNB to entry ST state.

A WTRU may start a survival time timer upon triggering the survival time state. The WTRU may deactivate the survival time state upon expiration of a ST timer. The WTRU may stop the survival time timer upon one or more of: receiving an ACK and/or SCI from the peer WTRU for the TB associated with ST requirement; receiving a DL indication from the gNB to exit ST state; and/or performing (e.g., making) a channel condition measurement below a threshold. The WTRU may report a state entry to the gNB, for example, if the WTRU is in coverage. Along with ST state reporting, the WTRU may report the cause of ST entry and/or associated channel condition measurements.

During a survival time state, the WTRU may perform one or more of the following added reliability processes (e.g., methods). During a survival time state, the WTRU may increase the transmit power level associated with one or more other (e.g., new) SL transmissions. During a survival time state, the WTRU may select a different SL resource (or resource pool) based on a measured CR/CBR. During a survival time state, the WTRU may change one or more resources used (e.g., switching to a different resource pool). During a survival time state, the WTRU may adjust the RSW such that the SL transmission fits with the ST remaining time. During a survival time state, the WTRU may activate autonomous blind retransmissions/repetition. During a survival time state, the WTRU may prioritize the transmission of a TB with ST requirement among one or more (e.g., multiple) TBs and/or other (e.g., new) transmissions and/or retransmissions.

A wireless transmit/receive unit (WTRU) may receive configuration information indicating that transmissions for a data radio bearer (DRB) associated with sidelink (SL) transmission can be performed in a regular quality of service (QoS) state and/or in a limited survival time QoS state. The WTRU may start a survival time timer, for example, based on a channel measurement and/or a determination that a transmission on a configured SL resource was dropped based on a channel occupancy ratio (CR) being above a threshold. The WTRU may transmit at least a first transport block (TB) based on the survival time timer running. The first TB may include data of the DRB in the SL in accordance with transmission parameters corresponding to the limited survival QoS. The WTRU may transmit at least a second TB based on expiry of the survival time timer. The second TB may include data of the DRB in the SL in accordance with transmission parameters corresponding to the regular QoS state.

The channel measurements may correspond to one or more of a channel busy ratio (CBR) being above a threshold, a measured CR being above the threshold, a measured reference signal received power (RSRP) associated with received SL control information (SCI) being above a second threshold, and/or a measured channel quality indication (CQI) being less than a third threshold.

The transmission parameters corresponding to the limited survival time QoS may include one or more of: an adjusted resource selection window such that a second SL transmission is within a remaining time in the survival time timer, an increased TB priority, a determination to bypass one or more channel busy ratio (CBR) congestion control restrictions, a determination to bypass one or more channel occupancy ratio (CR) congestion control restrictions, and/or a reselected SL resource.

The WTRU may determine to transmit the at least the first TB in accordance with the transmission parameters corresponding to the limited survival QoS state based on the channel measurement being above the threshold and/or dropping a transmission on the configured SL resource based on the CR being above the threshold. The at least second TB may be transmitted in a different resource pool.

The WTRU may start the survival time timer based on a pre-emption determination. The WTRU may start the survival time timer based on a sensing-based determination. While the survival time timer is running, the WTRU may temporarily disable congestion control and/or a CR limit.

The WTRU may stop the survival time timer based on reception of an acknowledgement for the first TB and/or second TB, reception of SCI, expiry of the survival time timer, reception of an indication from the network, and/or one or more channel measurements.

When the WTRU is in coverage, for example, the WTRU may send a report to a network. The report may include an indication of a transmission failure, a CBR being above a threshold, and/or the CR being above the threshold Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed is:

1.-22. (canceled)

23. A wireless transmit/receive unit (WTRU) comprising:
a processor configured to:
receive configuration information, the configuration information indicating that transmissions for a data radio bearer (DRB) associated with sidelink (SL) transmission can be performed in a regular quality of service (QoS) state or in a limited survival time QoS state, wherein the configuration information further indicates a scheduling request (SR) configuration for indicating SL transmission failure for the DRB when the DRB is in the limited survival time QoS state;
determine to use the limited survival time QoS state for the DRB;
determine that at least one transport block (TB) comprising data of the DRB that was transmitted in accordance with the limited survival time QoS state has failed; and
send a SR in accordance with the SR configuration for indicating SL transmission failure for the DRB when the DRB is in the limited survival time QoS state based on determining that the at least one TB comprising data of the DRB that was transmitted in accordance with the limited survival time QoS state has failed.

24. The WTRU of claim 23, wherein the processor is configured to determine to use transmission parameters associated with the limited survival time QoS state for the DRB, and send the new transmission for the DRB in accordance with the transmission parameters associated with the limited survival QoS state.

25. The WTRU of claim 23, wherein the processor is further configured to duplicate one or more TB transmissions on one or more configured grants (CGs).

26. The WTRU of claim 23, wherein the processor is further configured to start a survival time timer.

27. The WTRU of claim 26, wherein the processor is further configured to start the survival time timer based on a pre-emption determination, and the determination to use the limited survival time QoS state for the DRB is based on starting the survival time timer.

28. The WTRU of claim 26, wherein the processor is configured to start the survival time timer based on a sensing-based determination, and the determination to use the limited survival time QoS state for the DRB is based on starting the survival time timer.

29. The WTRU of claim 26, wherein, while the survival time timer is running, the processor is configured to temporarily disable congestion control or a channel occupancy ratio (CR) limit.

30. The WTRU of claim 26, wherein the processor is further configured to stop the survival time timer based on reception of an acknowledgement for a first TB or second TB, reception of SL control information (SCI), expiry of the survival time timer, reception of an indication from a network, or one or more channel measurements.

31. The WTRU of claim 26, wherein, while the survival time timer is running, the processor is further configured to activate autonomous blind retransmissions or increase the number of autonomous repetitions.

32. The WTRU of claim 23, wherein the processor is configured to send a new transmission for the DRB in accordance with the limited survival time QoS state, wherein in the limited survival time QoS state the WTRU is configured to select at least one grant for the transmission, wherein the selected at least one grant corresponding to at least one of: a grant having a highest relative reliability for a modulation and coding scheme (MCS) of a plurality of available grants, a configured grant associated with the limited survival QoS state, or a plurality of configured grants used for duplication of the new transmission.

33. The WTRU of claim 32, wherein the new transmission is sent in a different resource pool.

34. The WTRU of claim 23, wherein, when the WTRU is in coverage, the processor is further configured to send a report to a network, wherein the report comprises an indication of a transmission failure, a channel busy ratio (CBR) being above a threshold, or a channel occupancy ratio (CR) being above a threshold.

35. A method performed by a wireless transmit/receive unit (WTRU), the method comprising:
receiving configuration information, the configuration information indicating that transmissions for a data radio bearer (DRB) associated with sidelink (SL) transmission can be performed in a regular quality of service (QoS) state or in a limited survival time QoS state, wherein the configuration information further indicates a scheduling request (SR) configuration for indicating SL transmission failure for the DRB when the DRB is in the limited survival time QoS state;
determining to use the limited survival time QoS state for the DRB;
determining that at least one transport block (TB) comprising data of the DRB that was transmitted in accordance with the limited survival time QoS state has failed; and
sending a SR in accordance with the SR configuration for indicating SL transmission failure for the DRB when the DRB is in the limited survival time QoS state based on determining that the at least one TB comprising data of the DRB that was transmitted in accordance with the limited survival time QoS state has failed.

36. The method of claim 35, wherein the method further comprising determining to use transmission parameters associated with the limited survival time QoS state for the DRB, and sending the new transmission for the DRB in accordance with the transmission parameters associated with the limited survival QoS state.

37. The method of claim 35, wherein the method further comprises duplicating one or more TB transmissions on one or more configured grants (CGs).

38. The method of claim 35, wherein the method further comprises starting a survival time timer.

39. The method of claim 38, wherein the method further comprises starting the survival time timer based on a pre-emption determination, wherein the determination to use the limited survival time QoS state for the DRB is based on starting the survival time timer.

40. The method of claim 38, wherein the method further comprises starting the survival time timer based on a sensing-based determination, and wherein the determination to use the limited survival time QoS state for the DRB is based on starting the survival time timer.

41. The method of claim 38, wherein, while the survival time timer is running, the method further comprises temporarily disabling congestion control or a channel occupancy ratio (CR) limit.

42. The method of claim 38, wherein the method further comprises stopping the survival time timer based on reception of an acknowledgement for a first TB or second TB, reception of SL control information (SCI), expiry of the survival time timer, reception of an indication from a network, or one or more channel measurements.

43. The method of claim 38, wherein, while the survival time timer is running, the method further comprises activating autonomous blind retransmissions or increasing the number of autonomous repetitions.

44. The method of claim 35, further comprising sending a new transmission for the DRB in accordance with the limited survival time QoS state, wherein in the limited survival time QoS state the WTRU is configured to select at least one grant for the transmission, wherein the selected at least one grant corresponding to at least one of: a grant having a highest relative reliability for a modulation and coding scheme (MCS) of a plurality of available grants, a configured grant associated with the limited survival QoS state, or a plurality of configured grants used for duplication of the new transmission.

45. The method of claim 44, wherein the new transmission is sent in a different resource pool.

46. The method of claim 35, wherein, when the WTRU is in coverage, the method further comprises sending a report to a network, wherein the report comprises an indication of a transmission failure, a channel busy ratio (CBR) being above a threshold, or a channel occupancy ratio (CR) being above a threshold.
